(19) United States
(12) Patent Application Publication
(10) Pub. No.: US 2020/0074883 A1
(43) Pub. Date: Mar. 5, 2020

(54) DATA AGGREGATION, ANALYSIS, AND RESULTS REPORTING NETWORK FOR FITNESS STATE MANAGEMENT FOR USERS

(71) Applicant: Sergio Radovcic, Phoenix, AZ (US)

(72) Inventor: Sergio Radovcic, Phoenix, AZ (US)

(21) Appl. No.: 16/157,725

(22) Filed: Oct. 11, 2018

Related U.S. Application Data
(63) Continuation-in-part of application No. 16/122,491, filed on Sep. 5, 2018.

(51) Int. Cl. G09B 19/00; H04W 4/80; H04L 29/08; A63B 24/00; G09B 7/02

(52) U.S. Cl. CPC G09B 19/0092; H04W 4/80; H04L 67/18; H04L 67/22; A63B 24/0062; G09B 7/02; A63B 2220/17; A63B 2220/12; A63B 2220/62; A63B 2230/06; A63B 2220/72; A63B 2220/75; A63B 2220/73; A63B 2225/50

(57) ABSTRACT

A data aggregation, analysis, and results reporting network includes a first machine readable code running on a first network node tracking raw motion data, a second machine readable code running on a second network node tracking raw hydration data, a third machine readable code running on a third network node, the third network node receiving the raw data tracked and caching the data as a batch of data for processing and a fourth machine readable code running on a fourth network node receiving the cached data from the third network node and processing the data, the fourth network node having access to a fifth network node sending third-party data to the fourth network node during data processing of a received batch of data.

### CROSS-REFERENCE TO RELATED DOCUMENTS

This US patent application claims priority as a continuation in part to U.S. application Ser. No. 16/122,491 filed on Sep. 5, 2018. All of the disclosure contained in the four corners of U.S. application Ser. No. 16/122,491, filed on Sep. 5, 2018, is contained herein in this US patent application at least by reference.

### BACKGROUND OF THE INVENTION

### 1. Field of the Invention

The present invention is in the field of physical and nutritional fitness and pertains particularly to methods and apparatus for tracking general activity of users and providing recommendations relating to nutritional needs.

### 2. Discussion of the State of the Art

In the field of physical fitness, maintaining physical health and fitness is a concerted passion for people all over the world. Aside from user-operated fitness machines, there are many consumer products that have been developed to help people track their activities and pursue goals related to fitness. These products include mobile and often wearable electronics devices for tracking activity and certain states of a user performing the tracked activity at the time. An activity that may be tracked might be running, walking, swimming, dieting, lifting, cycling, and other activities pursued with a goal of attaining a level of physical fitness for the tracked user. It is estimated that over 2 million users are currently tracking their activities and pursuing some fitness goal.

Modular electronics devices are known to be able to track distance and time, running or walking, monitor heart rates, and blood pressures, sweat rates, breathing rates, and can calculate simple results such as the number of calories burned, electrolyte loss and so on during the activity. Mobile phone applications have been created that enable a user being tracked to upload data to a remote server where the data may be processed, and recommendations may be later sent to the user being tracked. Some of these products include but are not limited to running watchers, mobile phone apps, such as RunKeeper or Strava, or like activity trackers, such as FitEit or Jawbone. Forums are also a popular way of tracking physical fitness and health. These also allow the user to receive detailed feedback and recommendations. More particularly, these products work individually and do not aggregate the data from disparate data sources to produce personalized recommendations.

Currently, many products and mobile applications exist that may provide little or no generalized feedback to a user relative to attaining or improving upon on their health and fitness goals. People have differing needs based on their activities and other events. Without proper data aggregation, feedback may be sparse or even detrimental to the user due to variables that are not tracked or are unaccounted for.

The reference cited in the cross reference section describes a method for acquisition of fitness data and outputting personalized fitness data results and user recommendations for products benefiting users that have a temporary medical condition, more particularly pregnancy. The service spans the three trimesters of pregnancy plus 720 days of early childhood. The service involves searching for one or more tracking devices being operated by a pregnant user, connecting to the device and uploading the fitness data to a mobile phone running an application. The application on the phone may solicit data from the user through the application such as by prompt and receipt of answers to fitness questions, pregnancy questions, and prompt and receipt of answers to general questions about health, diet, and lifestyle behavior.

This data may be aggregated for that user and then processed along with fitness data from tracked activity to determine if any recommendations might be made to the user according to the fitness data results, solicited data from the user, and knowledge data provided by one or more nutritional experts in the area of pregnancy. The user may be shown an application results page for example, displaying recommendations including rational for any recommendations made. The user may also purchase vitamins, proteins, and electrolytes some of which may be prepared or mixed or selected especially for the pregnant individual.

There is a desire that nutritional information, especially recommendations or advice be relevant to an individual user or custom to that user as opposed to being general information based upon what may be known generally as beneficial to a certain group of people. There is also a desire that more precision with respect to customizing nutritional needs for an athlete and assisting that athlete in setting, maintaining, and achieving stated or agreed upon goals is required.

Therefore, what is clearly needed is a data tracking and nutritional advice and fulfillment network that combines real time tracked fitness data with solicited data, third-party held data referencing knowledge data to create and communicate interactive recommendations and notifications that are highly personalized for the athlete.

### BRIEF SUMMARY OF THE INVENTION

In accordance to at least one embodiment of the present invention and not withstanding variations thereof falling within the spirit and scope of the present invention, a data aggregation, analysis, and results reporting network for fitness state management for users is provided and includes a first machine readable code executed from a non-transitory medium running on at least one first network node, the first network node tracking at least raw motion data of individual ones of the users, a second machine readable code executed from a non-transitory medium running on least one second network node, the second network tracking at least raw hydration data of individual ones of the users, a third machine readable code executed from a non-transitory medium running on a third network node, the third network node receiving the raw data tracked by the at least one first and second network nodes and caching the data as a batch of data for processing, and a fourth machine readable code executed from a non-transitory medium running on at least one fourth network node, the fourth network node receiving the cached data from the third network node and processing the data wherein the at least one fourth network node has network access to at least one fifth network node, the fifth network node sending third-party data to the at least one fourth network node during data processing of a received batch of data. The at least one fourth network node sends processed data results back over the network to the third network node, the results relevant to the last received and processed batch of data while the third network node is receiving in real time subsequent raw data from the at least one first network node and the at least one second network node and caching that data as a subsequent batch of data for data processing into results.

In one embodiment, the at least one first network node is a wearable data tracking device adapted to track at least motion data and the at least one second network node is a liquid tracking device installed on a water bottle as a cap piece to the bottle. In one embodiment, the third network node is a smart phone having a user interfacing browser-based SW application executed and running, and wherein data received from or sent to the at least one first network node and the at least one second network node is transmitted over a Bluetooth LE™ wireless network.

In one embodiment, the first machine readable code and the second machine readable code call out in aggregate specific data types tracked and aggregated including but not limited to motion data, hydration data, direction of motion data, time data, date data, heart rate data, temperature data, time of ultraviolet light (UV) exposure data, humidity data, and elevation data. In this embodiment, the third machine readable code contains instructions for at least receiving raw tracked data, sorting received raw tracked data, caching received and sorted raw tracked data as a single batch of data, and sending the received, sorted, and cached raw tracked data as a single batch of data. Also, in this embodiment, the fourth machine readable code contains instructions for at least receiving the sorted tracking data as a batch of data for data processing, normalizing the batch of data for data processing, receiving third party data, mapping received third party data to processing input, and storing the resulting data after processing as a batch of processed results data.

In one embodiment, the at least one fifth network node is a GPS information server serving user location and providing live mapping services for the user. In one embodiment, the at least one fifth network node is a weather forecast server serving current and forecast weather information including but not limited to current or forecast temperatures, humidity levels, wind speeds, pollen counts, general air quality levels, pollution particulate counts. In one embodiment, the at least one fifth network node is an original equipment manufacturer (OEM) server serving specifications of equipment registered for use during tracking of data of the users. In one embodiment, the at least one fifth network node is a video server serving local video of users participating in a tracked activity the video data appended with traffic data pertaining to several other users at the activity and their locations along the active route.

In one embodiment of the present invention, the data aggregation, analysis, and results reporting network further includes a sixth network node in a network communication path between the at least one third network node and the at least one fourth network nodes, wherein the sixth network node functions as a proxy server and communications broker between the at least one third network node and the at least one fourth network node. In this embodiment, the sixth network node has access to user labs data, user order history data, and user profile data, and may serve that data to the at least one fourth network node upon request from the at least one fourth network node during processing of tracked data and third-party data.

In one embodiment, a batch of data cached on the at least one third network node is defined as data collected and received over a specified proportional and repeated period of time within the overall activity period. In another embodiment, the data aggregation, analysis, and results reporting network of claim 1, wherein a batch of data cached on the third network node is defined as data collected and received the aggregate thereof having a predefined data weight equal to a batch weight of data.

In one embodiment, the data aggregation, analysis, and results reporting network further includes an optional fifth machine readable code executed on demand from a non-transitory medium running on a seventh network node, the seventh network node tracking at least weight data of individual ones of the users, wherein the weight data is compartmentalized into sub-values of total measured weight of the individual user quantifying at least lean muscle weight, and visceral fat weight, and wherein the data from the seventh network node is cached at the third network node independently of active raw tracking data cached as batch data. In this embodiment, the seventh network node is a weigh scale adapted with an embedded bio electrical impedance system.

In one embodiment, wherein the third network node is a smart phone running a browser-based SW application, results of data processing include result data added to user labs data, the user labs data maintained on the network for the user and accessible to the user through the smart phone application. Also in this embodiment, a portion of the results of data processing are utilized in further data processing at the at least one fourth network node to generate recommendations and or notifications that are sent back over the network to the smart phone application and, in some cases, on through the smart phone to the at least one first and or the at least one second network nodes for display.

In one embodiment, a batch of data is defined as all tracked raw data collected from a single tracked activity or, as all tracked raw data collected during a period of time. In one embodiment, the batch of data is equivalent to all of the tracked data for a single period of activity tracking and wherein data tracking, data transfer, data processing, and data and recommendation and notification activities occur continuously during the tracking period.

### BRIEF DESCRIPTION OF THE SEVERAL VIEWS OF THE DRAWINGS

FIG. 1 is an architectural overview of a communications network supporting activity tracking and product fulfillment according to an embodiment of the present invention.

FIG. 2A is a front elevation view of the motion tracking device of FIG. 1.

FIG. 2B is a side view of the motion tracking device of FIG. 2A.

FIG. 3 is a block diagram depicting circuitry of the motion tracking device of FIG. 1.

FIG. 4 is a sequence diagram depicting node connectivity, data aggregation, data access, processing, and updating.

FIG. 5 is a front elevation view of the connected bottle of FIG. 1.

FIG. 6 is a process flow chart depicting steps for getting started and using the service the first time.

FIG. 7 is a sequence diagram depicting node connectivity, data aggregation, data access, processing, and updating within the time window of a live activity.

FIG. 8 is a block diagram depicting a data process input model.

FIG. 9 is an exemplary transcript of an artificial intelligence (AI) service communication with a user planning a future activity according to an embodiment of the present invention.

FIG. 10 is a block diagram depicting data source nodes accessible to a recommendation engine for generating system recommendations.

### DETAILED DESCRIPTION OF THE INVENTION

In various embodiments described in enabling detail herein, the inventor provides a unique data aggregation, analysis, and results reporting network for fitness state management for users. The present invention is described in enabling detail using the following examples which may describe more than one relevant embodiment falling within the scope of the present invention.

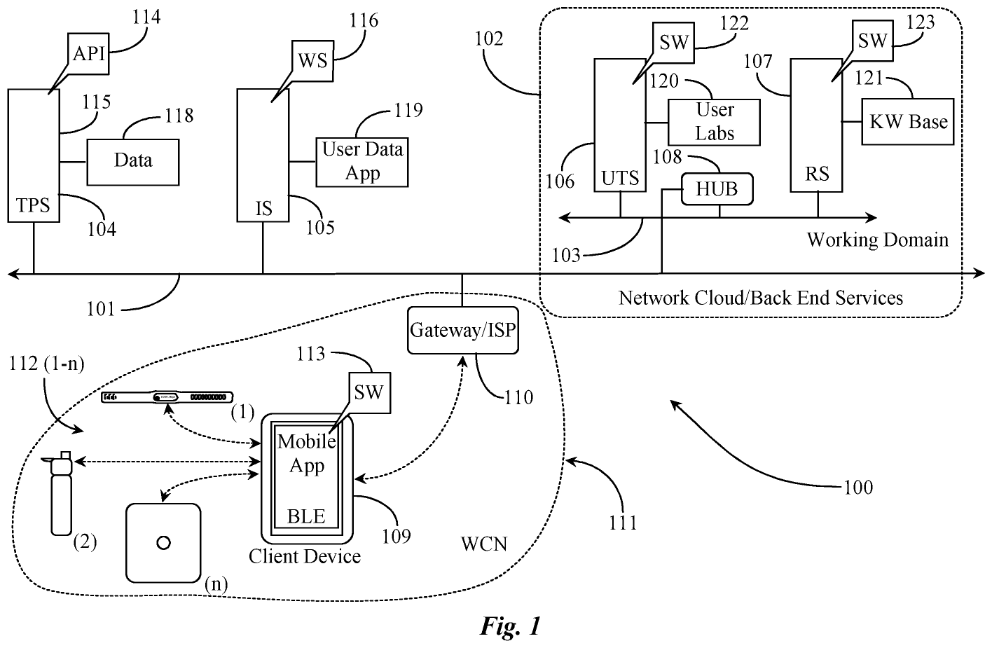

FIG. 1 is an architectural overview of a communications network 100 supporting a data aggregation, analysis, and results reporting system for fitness state management for users according to an embodiment of the present invention. Communications network 100 includes the well-known Internet network referenced herein as a network backbone 101. Network backbone 101 represents all the lines, equipment, and access points that make up the Internet network including any connected sub-networks. Therefore, there are no geographic limitations on the practice of the present invention. Network backbone 101 may also be referred to in this specification as Internet 101. Backbone 101 may be that of a corporate wide-area-network (WAN), a private WAN, a municipal area network (MAN) without departing from the spirit and scope of the present invention.

Internet 101 is accessible through a gateway 110 hosted by an Internet service provider (ISP). Gateway 110 may bridge a wireless carrier network (WCN) 111 to Internet 101 for connectivity. Internet 101 supports an information server (IS) 105 adapted to serve web pages and websites to users upon user request. Server 105 hosts a website (WS) 116. WS 116 may serve as an access point for users to join and subscribe to the service of the invention. Server 105 has connection to a data repository 118 adapted to contain data about subscribed users (clients) and data about a client software (SW) application 113 that may be provided for download to potential clients wishing to subscribe to the service.

SW 113 is depicted on a client smart phone 109 that has access to Internet 101, server 105, and website 116, through gateway 110. SW 113 may be downloaded and installed on smart phone 109 by a fitness tracking user. In this embodiment, the user may be an athlete in training or any other user having one or more than one tracking device and application 113. SW 113 is a dedicated thin client application that provides a vehicle for passing aggregated fitness activity data to a tracking and recommendation service for data processing. SW 113 is also a browser-based user interface (UI) for ordering nutritional supplements, micro nutrients, electrolytes and other products that are specially adapted for goal-oriented athletes and general fitness users.

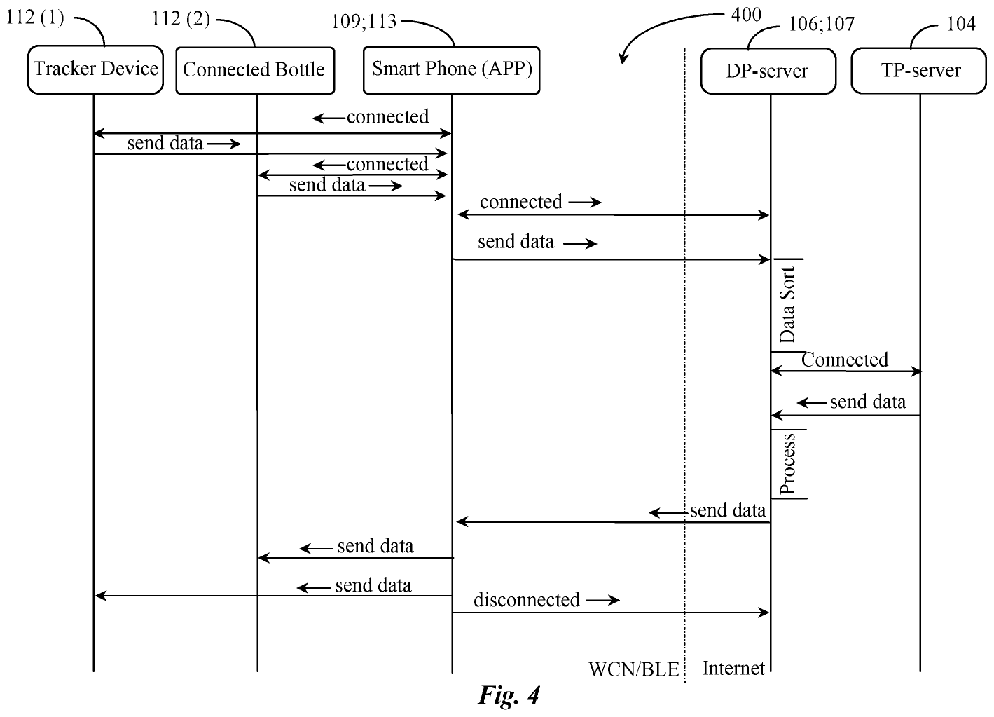

Referring now to FIG. 4, application 113 may be available on a non-transitory medium with available fitness tracking hardware devices 112 (1−n) as a kit that may be purchased. Tracking device (TD) 112 (1) is a motion-sensitive fitness data tracking device (TD) worn as a wrist band. A user operating smart phone 109 aided by SW 113 may have wireless data communications access to tracking device 112 (1) hereafter TD 112 (1). TD 112 (1) is an electronic activity tracker that functions to track movement of the client, like walking, running and other motion-based activities like swimming, exercises, including sleep (intermittent movements in a single location inferring a sleep activity).

TD 112 (1) is in the physical form of a device attached or otherwise integrated with a wrist band that may be worn by a user. TD 112 (1) may, in some embodiments, be modified to clip on a belt, worn as an arm band, or some other wearable item based on the availability of accessory parts. TD 112 (1) is adapted in this embodiment as a Bluetooth™ enabled tracking device that may be paired to client-operated smart phone 109 which, is also Bluetooth™ enabled for short range wireless communication. More particularly, the means for communication between phone 109 and TD 112 (1) is Bluetooth Low Energy™ (BLE). The wireless technology used however may be any wireless protocol technically available. TD 112 includes a data display and may send data, receive data, and display data on demand for a user.

Another device that may be provided to a client operating smart phone 109 is an electronic bottle 112 (2). Bottle 112 (2) is a Bluetooth™ (BLE) enabled device that a client operating smart phone 109 may use while engaging in activities that may be tracked relative to motion tracking device 112 (1). Bottle 112 (2) may communicate with smart phone 109 using BLE. Bluetooth™ Low Energy is different from Bluetooth™ only in that BLE has a low power sleep state that wakes up when the device beacon is recognized by the smart phone running application 113. Bottle 112 (2) is adapted by sensor to report volume of liquid that passes the cap portion of the bottle. The bottle may indicate loss of volume periodically and may receive notification from smart phone 109.

A client operating smart phone 109 aided by SW 113 may also have access to one or more other electronic devices like an electronic weight scale 112 (n) of FIG. 1. Weight scale 112 (n) is adapted as a smart weigh scale having a capability of weighing total weight, body mass index (BMI), bone density, and can separate lean body mass from fat. Weight scale 112 (n) is enabled for Bluetooth™ and can communicate over a Bluetooth™ network with a client operating smart phone 109. Weight scale 112 (n) may provide granular weight data that is not trackable using a motion TD like TD 112 (1). Therefore, a user may weigh in and weight scale 112 (n) will automatically send the categories of weight data to application 113 using wireless communication like BLE. Weigh scale 112 (n) may be described as a smart scale adapted to measure total body weight, total body fat, total muscle mass, total water content, bone mass, bone density, and visceral (abdominal) body fat percentage to reveal lean muscle weight. Scale 112 (n) utilizes an embedded bioelectrical impedance system for determining the subset data such as water content, bone density and mass, in addition to fat weight versus lean muscle weight measurements and the like.

In one embodiment, a client operating smart phone 109 aided by application 113 may have access to one, a combination of, or all of devices 112 (1−n). In a general embodiment, the client must use at least the TD 112 (1) for activity tracking and may optionally add another device like bottle 112 (2), and scale 112 (n). Each device produces its own unique device-specific data and general data of interest to the client. It is desired that more than one device may be used in combination to produce unique data sets that may be uploaded over Internet 101 to a data processing and client fulfillment and recommendation service such as working domain 102.

Working domain 102 represents the back-end part of the tracking and recommendation service in one embodiment. Working domain 102 may be a set of reserved cloud servers and repositories and data processing tools (SW) that are strategically adapted to provide a stable base history of the fitness state of a client including making recommendations to the client, and fulfillment services for the client for products like vitamins, electrolytes, foods, proteins, micro-nutrients, etc. Athletes and general users of the system will have very different nutritional needs based on different goals they may have. Therefore, the service of the invention controls a line of nutritional products that may be mixed or formulated to obtain optimum nutritional maintenance for specific sub-groups of users. Moreover, formulas such as protein/nutrient formulas or vitamin formulas may be altered or custom mixed for users based on personal physique, gender, age, and fitness state (relative to goal) wherein the data results have already calculated at least once from aggregated activity data and third-party data and documented in user labs (data space reserved) for a client. User labs are navigable via application 113 on smart phone 109.

Working domain 102 includes a local area network (LAN) having connection to Internet 101 through a data network hub 108 such as with an Ethernet network for example. LAN 103 supports a data processing server 106 labeled a user tracking server (UTS). User tracking server 106 hosts a SW application 122 adapted to receive aggregated data, normalize that data for processing, and processing the received data to results that may be maintained in a server-connected data repository 120 adapted to contain client data formatted as user labs data. User labs data may include but shall not be limited to the client's latest physical state, the current amounts of vitamins/nutrients a client is consuming on a regular basis, the statistics (base state) of the client relative to nutritional health, hydration, and the statistics relative to a client's weight, BMI, etc. (base state).

Data calculated and stored in archive for a client (user labs) may include goal-oriented data wherein a goal data set may be presented against a current data set (real data) for any of the categories of data available for viewing. The tracking service cooperates with a recommendation service, referenced herein as recommendation SW 123 hosted on a recommendation server 107. Such cooperation may result in improvements in the client's nutritional and electrolyte intake and in the recommendations of certain activities to the client to help optimize client pursuit of one or more stated goals of that client relative to health and fitness state.

User tracking server 106 may receive data from a client such as one operating to smart phone 109, for example. In one embodiment, information server 105 and website 116 function as a proxy and may broker the connection between cloud-based services and the client device. Client device 109 running SW 113 may access any activity data from TD 112 (1) and connected bottle 112 (2) over an established Bluetooth LE™ (BLE) connection requiring device/phone paring and network node discovery. In one embodiment, TD 112 (1) may automatically send all its tracking data whenever the wireless connection is active between the TD and smart phone. Tracked data may include motion data including steps or strides taken, direction of or route of travel (GPS), heart rate, respiratory rate, blood pressure rate, local ambient temperature, and exposure levels to ultraviolet radiation (UV). In a BLE network the TD is in sleep mode and wakes up once recognized by the smart phone saving energy.

Application 113 may also receive data from any other device the client is using as they are all wirelessly enabled for Bluetooth™ LE. Bottle 112 (2) may provide hydration rate over a tracked period such as number of ounces a user has consumed up to a reporting period. Bottle 112 (2) may receive updates or notifications informing a user of times during an activity where it is appropriate to hydrate wherein the notification may also recommend the amount to drink at one time. A visual indicium may present on display for a user informing of when to refill a bottle. A user may also see the temperature of the liquid within the bottle.

Scale 112 (1) may provide weight data separated into categories such as a body mass index, lean mass, bone density, muscle tone, visceral fat count, etc. In one embodiment, bio-electric impedance analysis (BIA) is incorporated into the scale top surface and circuitry to enable calculation of overall weight, total body water (TBW), lean fat-free mass, visceral fat, overall BMI, bone mass and density.

It is noted herein that an athlete operating smart phone 109 may practice the invention with only the TD 112 (1) and the client application without departing from the spirit and scope of the invention. It is also clear to one with skill in the art that the client may use all the illustrated devices or any combination thereof including the wrist tracking device. In one embodiment of the present invention, all the device data is uploaded to the smart phone 109 through application 113 and Bluetooth™ connectivity. Data aggregated from the sum of devices including the tracking device may be uploaded to UTS 106 running SW 122. The data may be received on behalf of a client and normalized for data processing. Normalizing data may mean recalculating for uniform metrics, averaging or rounding figures, sorting according to a data model or according to some priority, formatting data received from a third-party tracking device and the like.

In one embodiment, SW 122 may access third-party data from one or more local or regional information sources such as a weather service, for example, to get Geo-specific temperature data, Geo-specific weather predictions, humidity levels, pollen levels, and particulate levels, that may influence the experience of and or comfort of a client being tracked. A third-party server (TPS) 104 is depicted supported by Internet 101 and connected to a data repository 118 adapted to contain third party data.

In one embodiment, discovery of third-party information is governed by rule or constraint. For example, if a client determines to jog a specific route having a known length at a specific time and date, the system may aid the client by planning the hydration and nutrition associated with the jog. The system may access third party data any time before the event to determine the predicted climate during the planned activity and whether it will affect recommendations sent to the client.

Hot temperature along the route may cause more water loss than normal leading to a special recommendation for a measured number of additional electrolytes and maybe a protein bar listed in the user's account as a product the user may have access to or one the user has not purchased. In this case the protein bars may be part of a recommendation that may translate into a transaction made by the client through the client application, the transaction based on a recommendation made to the client after processing data about the client. The processed data may be saved on behalf of the client in repository 120 user's labs data. The fresh data in repository 120 may also be processed in comparison to user lab's history of the same data reproduced over time. Therefore, data in user's labs may be refreshed daily or at will of the client.

SW 123 outputs the resulting processed data to recommendation server 107 running recommendation SW 123. Recommendation SW 123 is adapted to read results received and determine, with additional calculation if necessary, whether any recommendations or special insights or other notifications should be ordered for a user because of a noted shift or deviation of certain data from norm in user labs or from system recognition of data relative to ordering product such as a notification to re-order a supply of vitamins, or a recommendation to switch from one protein type to another protein type. A base normal for an active athlete may be established relatively early through repetitive tracking and adjustment of calculated results. Recommendation engine 123 may create general notifications for encouragement, congratulations on goal achievements, tips or advice relative to any data. In one embodiment, SW 123 may participate in chat conversations with a client through application 113 using artificial intelligence (AI), optical recognition for images and text, and interactive voice recognition capabilities (IVR). Such conversations may be adapted to service the client such as setting up a planned activity and estimating benefit for the client, or simply logging nutrition consumption data reported by the client into that client's user labs. In one embodiment, AI interaction services include AI coaching for goal-oriented athletes who subscribe to it. For example, an athlete who is a marathon runner with a goal of conditioning for a 20-mile race three months away may utilize an AI coach to help with advice, recommendations, and the accompanying logic or information validating the advice.

An AI coach may assist the user in helping create future activities (through recommendation) that will be most relative to attaining the user's goal. Attributes of an activity such as jogging or running may include but are certainly not limited to the average rate of speed of the user during the activity, the length of the route taken by the user, the ambient temperature at the route Geo-location, the grade or slope of the route up or down (if not flat) or both up and down if hilly, and general illumination along a route (night).

In one embodiment, the system may be able to predict traffic on an activity route at a certain time based on third party data, such as registration information for a group activity like a marathon. If a route has third party cameras, the system may be able to access those feeds (cams) and make real time calculations about traffic on a route ahead of a user running the route. The user may receive a notification about traffic further up on the route or if a rout is detoured or blocked, etc. An AI coach platform operated through application 113 by the user may scan in bar codes, recognize certain images and text, and provide supportive information to the user such as a Geo map of a route the user plans to hike or jog.

Recommendation server 107 aided by recommendation engine 123 may access a base of previously compiled knowledge in data repository 121. Experts in nutritional science contribute to and may provide updates to information held in data repository 121. Data within repository 121 may include results and methods of clinical trials and knowledge data resulting of clinical study along with general knowledge data surrounding nutrition where it applies to goal-oriented physical states. Furthermore, the knowledge in repository 121 may include knowledge data about standard specifications relative to equipment and or accessories that may be used during an activity. In one embodiment, a user may report specification data about a piece of equipment or implement the user will leverage during a tracked activity. More data about incorporating equipment specification into user lab data processing will be provided later in this specification.

Recommendations may include product order recommendations designed to provide optimum nutritional health of the user in alignment with goals the user has set. The AI coach or adviser may validate a user goal or may inform a user that a stated goal is not achievable, for example, in a referenced time frame and may then produce alternative goal attribute for the user that are more logically achievable without disconcerting the user. Nutritional requirements may change over the course of goal attainment and after attainment of a goal. The system of the present invention considers mitigating factors described above and adjusts nutritional recommendations directed to the client. The system of the invention tracks proteins fats (animal/vegetable) and carbohydrates (PFCs) including micro-nutrients (vitamins, minerals etc.) and relates to each user on a personal basis in recommending the above products for user consumption, wherein those recommended products are integral to attainment of that user's specific goal or goals. The system may track exposure to sun through UV sensors and calculate vitamin D requirements and how much vitamin D is revealed from foods eaten to determine whether a client may be deficient and needs more vitamin D. The client application may automatically input the exposure data and calculate from reported food consumption data information to figure out if you have achieved an RDA (Recommended Daily Allowance).

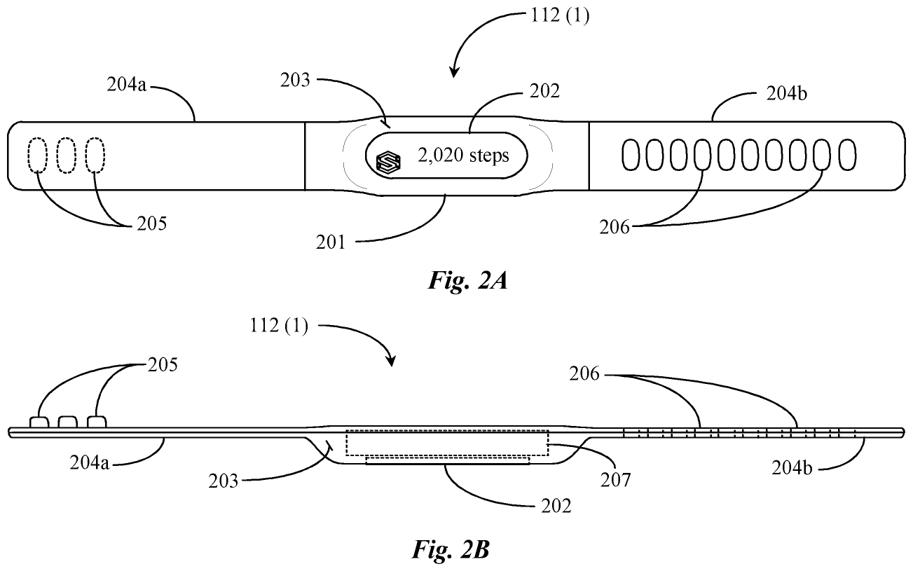

FIG. 2A is a front elevation view of motion tracking device 112 (1) of FIG. 1. Tracking device 112 (1) is depicted in the form of a wrist band in this embodiment. Tracking device 112 (1) comprises a hardware electronic device 201 having a touch screen display 202. Touch screen display 202 may be a liquid crystal display (LCD) that may be a monochrome display (black and white). Any type of touch screen display may be provided without departing from the spirit and scope of the present invention such as an organic light emitting diode (OLED) display for example. Display 202 may be a resistive display or a capacitive display.

Touch screen display 202 includes a company logo graphic depicting an S for Styr™ in the lower left corner of the screen. The company logo is a touch point for tapping screen 202 to review data collected by device 201 or sent to the device over Bluetooth™ from the user's smart phone running the Styr™ application 113. In this example, screen 202 is displaying the number of steps tracked by the device over a period of time. Continued tapping of the company logo scrolls through data points that may be displayed on screen 202.

Module 201 is removably mounted into a pocket 203 of sleek silicone wrist band having wrist straps 204A and 204B. Strap 204B includes ovoid through openings 206 equally spaced in a line along the length of the strap. Strap 204A includes a plurality of ovoid connect tabs adapted dimensionally to be inserted into openings 206 to secure the wrist band on to a user's wrist. It is noted herein that tracking device hardware module 202 may be removed from silicone band pocket 203 and placed into a belt clip accessorize having a dimensionally same pocket to accept the hardware. The band may be worn on the wrist, arm or the ankle. Hardware 201 may be placed in a belt or pocket clip device or worn in a different manner without departing from the spirit and scope of the invention. In one embodiment, tracking module 201 is a water proofed device that may withstand submersion in water, for example, swimming with it.

In one embodiment, module 201 remains in a sleep mode until it is moved whereby a motion sensor within the device picks up the motion and wakes or boots the device. In another embodiment, a tap on the screen logo in the corner of screen 202 wakes the device for both active data tracking and Bluetooth™ communication with the user's smart phone running application 113. Other data points that might be displayed may be date and time, time of tracking in minutes, seconds, or other intervals, distance traveled in feet, miles, or other measures, calories burned, and ounces of liquid consumed (hydration).

FIG. 2B is a side view of motion tracking device 112 (1) of FIG. 2A. Wrist band pocket and wrist band straps 204A and 204B may be one contiguous molded part made from a resilient but flexible silicone material. Other forms and materials might be leveraged to house the tracking module (201) such as a molded belt clip. In one embodiment module 201 of FIG. 2A may be attached to a chain and worn as a pendant, a wrist chain or anklet chain. In this example, a flexible wrist band safely secures the tracking device module to the user.

Tracking device 112 (1) includes a compartment 707 (broken rectangular boundary) in the tracking module adapted to house the circuitry and sensors provided and used in the tracking device. In one embodiment, tracking device 112 (1) includes a rechargeable lithium ion battery (long life) battery. A USB charge cradle (not pictured) may be provided that includes a pocket mounting location for the device module 201, and which can be plugged into a computer USB port to recharge batteries of the device. It may be noted herein that empirical tests note an average long battery life of four weeks or more.

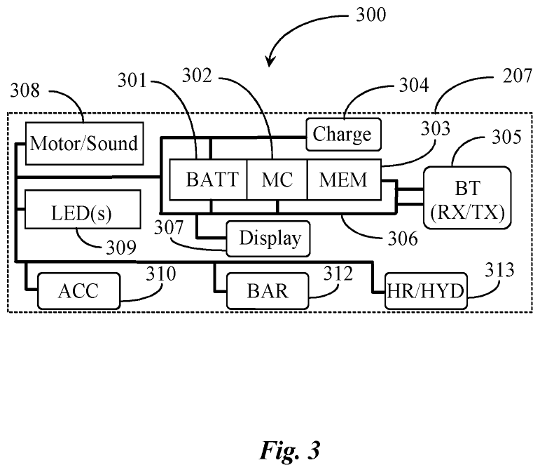

FIG. 3 is a block diagram depicting circuitry 300 of motion tracking device 112 (1) of FIG. 1. Compartment 207 may house a battery (BATT) 301, a micro-controller (MC) 302 board with memory (MEM) 303. A logical bus structure 306 is depicted herein using 2-point line to demonstrate power distribution paths to components and communications paths between components. A charge interface circuit 304 is provided for interface with pads on a USB charger cradle. Charge interface 304 may also be a port circuit adapted to accept a charge plug.

A Bluetooth™ Low Energy wireless communications chip (RX/TX) 305 is provided to enable communications between a smart phone (109, FIG. 1) running application (113, FIG. 1) and the tracking device 112 (1). A display circuit 307 is provided to run the LCD touch screen display (202) of FIG. 2A. Circuitry 300 may include a motor (vibration) and sound circuit 308 adapted to vibrate and or produce a haptic feedback if triggered to do so by routine event such as a received notification from a smart phone (109, FIG. 1) running the tracking application (113, FIG. 1). In one embodiment haptic feedback may be in form of lights or vibration. Any other type of haptic feedback may be used as well. LEDs circuit 309 is provided to back light touch screen display (202, FIG. 2A).

Circuitry 300 includes an accelerometer (ACC) sensor 310 that may provide the motion tracking capability of the tracking device. Sensor 310 may be adapted to track motion, direction of motion, number of steps or the like executed, orientation, and time. Sensor 310 is not limited to an accelerometer in one embodiment but may be a gyroscope or another motion sensor without departing from the spirit and scope of the invention. In one embodiment, circuitry 300 includes a barometer (BAR) and ultra violet (UV) sensor 312. Sensor 312 may be two separate sensors a barometer and a light sensor or a combined device that performs both functions.

Sensor 312 may track exposure levels of a user to sunlight over a tracked period. This may be useful in determining vitamin D requirements and maintaining a stable level. Sensor 312 may measure atmospheric pressure and determine altitude and humidity levels. In one embodiment an altimeter may replace the barometer function. Circuitry 300 may include a heart rate (HR)/hydration (HYD) sensor 313. Sensor 313 may be a combined device capable of measuring a user heart rate and detecting a sweat or perspiration rate of a user over a period of activity tracking. Hydration is directly important to a user performing an activity. Detecting both perspiration rate and actual liquid ounces consumed over time provides rich data to the system for calculating appropriate hydration levels for a user. Moreover, adding electrolytes provides additional support against an imbalance of proper hydration, salt levels, and the like.

A coded set of instructions or FW 311 is provided and is executable from MEM 303. FW 311 contains all the instructions for booting up from a sleep mode, operating wireless communications, waking up sensors, driving the touch screen display and caching sensor collected information for wireless transfer from the tracking device to the user smart phone running the tracking application.

In one embodiment, firmware hereafter FW 311 comprises a micro-operating system and platform for collecting sensor data and transferring the collected data in a push mode or request receive mode to the user smart phone for subsequent pass along of that data to the processing server on the larger network. In one embodiment, FW 311 may include logic for reducing redundancy of some data collected or for turning off specific sensors that might not be required in an activity.

It is also noted herein that by combining the data gathering capabilities of the tracking device (112 (1), FIG. 2A) and the connected bottle (112 (2), FIG. 1) with the capabilities of the smart phone (109, FIG. 1) aided by SW (113, FIG. 1), more accuracy and granularity may be achieved in calculated user labs results. Weigh scale 112 (n) provides yet another source of input data the tracking system uses along with user-reported nutritional data. Scale 112 (n) may provide weight data separated into categories using bio-electric impedance analysis (BIA) like body mass index (BMI), lean muscle mass, bone mass and density, muscle tone, visceral fat count, total body water (TBW), etc.

FIG. 4 is a sequence diagram 400 depicting node connectivity, data aggregation, data access, processing, and updating. In this sequence it is assumed that a client has smart phone 109 on with application 113 running. It is noted that application 113 may have a background mode that uses less power wherein the application is not actively receiving data or sending data or otherwise running but not in active use by a client.

A user or client operating phone 109 aided by running application 113 may detect and become connected with tracking device 112 (1), which may be assumed has been tracking data for a period leading up to a transfer (send) of tracked data from the tracking device to the smart phone. For example, a period might be twenty minutes where at every twenty minutes into an activity, the device pushes the accumulated data to the phone over Bluetooth™. Likewise, the client operating phone 109 aided by SW 113 may detect and become connected to bottle 112 (2), which may be assumed has been tracking hydration data (ounces consumed) for a period leading up to a transfer (send) of tracked data from the connected bottle to the smart phone.

It may be the user connects with the bottle first then the motion tracking device instead of the depicted order. Device connection refers to wireless recognition of the devices as active on the wireless network. Device detection and connection may be made shortly after or some appropriate time after the devices have been powered on and actively in use collecting raw data. In one embodiment, as soon as application 113 is executed device recognition over the network occurs automatically if BT is on in the phone settings. Rather than processing data locally on smart phone 109, the user connects online (Internet) through the running application to a data processing (DP) server 106 running data processing application 123 (reference FIG. 1).

In a variation of the above embodiment, a web service hosted through a website may server as a proxy connection and communications broker between the smart phone/application and the data processing server and application. In a proxy embodiment the web service may handle authentication of the user to the data processing server and may serve the local user labs data to the user's application. Once connected the smart phone application 113 may transfer (send) the batch data received from both connected tracking devices to the data processing server 106 aided by SW 123 for processing.

Before processing, server 106 aided by SW 123 may sort data and normalize data for subsequent processing. Data processing server aided by application 123 may forge a connection with (connect) to at least one third party data server represented in this sequence as third party (TPS) server 104. Data processing server 104 may represent one server serving a single data point like Geo-location of the user, or it may represent more than one server holding disparate types of data identified as useful to the data processing routines. Once connected, the third-party server may send third party data to the data processing server to use as weighing factors or even actual variables in calculations of data such as calories burned during a period of active tracking.

After a data processing window, processed data results may be sent to user's labs, which the client may access from the smart phone application 113. In one variation of the embodiment, the data results produced by data processing server 106 aided by application 123 are pushed to a web service hosting user's labs and providing the user with application 113 to access the data. Therefore, in one embodiment a client may need to refresh the smart phone application (sync to server) while connected to the web site (proxy) to access the new user labs data.

It is noted herein that recommendation and notification services are intentionally left out of this sequence 400. In actual practice data results are also passed off to a recommendation and notification service (may be hosted on a same processing server). Notifications and recommendations may be generated and propagated to a client through the smart phone application 113, but do not necessarily affect user labs data, which may be accessed as soon as an update occurs. In one embodiment a notification may be sent to the client that a user labs update has been performed.

Smart phone 109 aided by application 113 may send current data value notifications to connected devices for touch screen data display as accessed by the user while those devices are still active such as total calories burned currently during an activity. If an activity is part of a stated goal, then a user may receive a notification of the number of calories left to burn in the activity to stay on track with the goal parameters. Goal parameters may be set between a user and an AI coach or in one embodiment, a live coach interacting with a client from a remote device located on the network.

A stated or planned goal may include the number of activities planned to attain goal fitness results such as the desired weight of the client at the end of a goal period, the desired conditioning state of the user relative to tone, muscle build or BMI at the end of the goal period, and a nutritional plan recommending the type and quantities of vitamins, nutrients, proteins, and electrolytes to be consumed by the client to help in maintaining optimal health throughout the process of working to attain the planned goal.

Other display data points may simply be called up and displayed on the connected device touch screen any time during an activity. A client may disconnect from the data processing server after a batch update until the next timed interval for data transfer and processing. It is noted herein that a batch data period for the connected water bottle may be different than a batch data period for the wrist band tracking device without departing from the spirit and scope of the present invention. Weigh-ins using the smart scale 112 (n) may be scheduled on a regular basis and communicated from the scale to the smart phone application and then to the data processing server.

The service may log all information reported by a user including weight measurements food types eaten, vitamins taken, nutrients consumed, electrolytes consumed, and so on. Recommendations may be made to the client relative to diet and relative to the types and amounts of vitamins, proteins, electrolytes, and nutrients the client purchases through the smart phone application. Recommendations are based on data aggregation and analysis of the aggregated data considering archival data (user labs), third party held data including at least Geo-location data of the user, and current order process state and inventory state of the client with respect to products purchased and used by the client. For example, a liquid vitamin packet may be a daily consumable for the client 30 of these packets may then constitute a month supply of vitamins for a client therefore, the service knows (assumption of one packet consumed per day) when the client needs to reorder or be re-billed (blanket order) for shipment of vitamins.

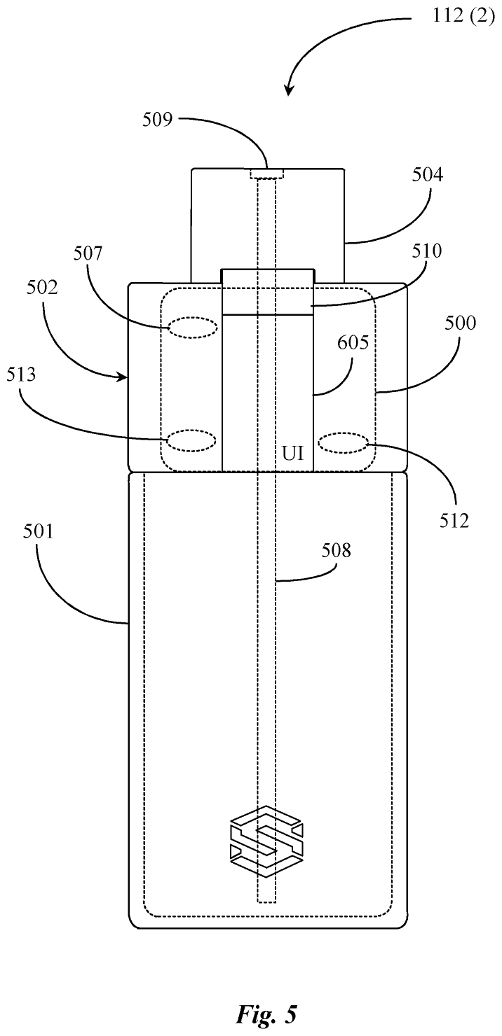

FIG. 5 is a front elevation view of the connected bottle of FIG. 1. Bottle 112 (2) is a Bluetooth™ LE enabled device that a client operating smart phone 109 may use for maintaining hydration level. Bottle 112 (2) is adapted by sensor to report volume of liquid that passes through the cap portion of the bottle, which contains the electronics. The bottle may indicate loss of volume periodically, receive notification from the client smart phone among other capabilities.

An athlete may consider a good hydration level as critical in maintaining a competitive edge in a marathon, a desert endurance race, or other like activities. Hydration is a critical component of general health as well as dehydration is very serious and may have detrimental side effects. Many people do not drink enough water as might be recommended by a professional with knowledge and may easily fall into a stage of dehydration without recognizing that or symptoms of dehydration that might appear.

Connected bottle 112 (2) includes a sterile stainless-steel container of about a 17-ounce volume. The container portion is male threaded at the top to accept a smart electronic bottle cap 502. Cap 502 may include sealing gaskets (not depicted). Cap 502 includes electronics 500 (broken rectangle), which may include sensors for tracking hydration rates, and some ambient conditions that could affect hydration recommendations, especially for a goal-oriented athlete.

Cap 502 includes a spout 509 connected to a straw 508 that passes through the cap some distance into the container portion 501. Electronics 500 within cap 502 are sealed from the ambient environment and in one embodiment is protected through water proofing techniques for electronics so that the bottle is waterproof. Cap 502 includes a top spout cover 504 that may be spring loaded and hinged at one side of cap 502. A retainer plate 510 is included and may lock the top cover 504 over drinking spout 509.

In one embodiment a part of cap 502 may include a spring-loaded twist lock mechanism in line with cover 504 whereby a client may twist the twist lock in one direction to release cover 504 and in an opposite direction to lock it back down. In one embodiment spout 509 is aligned to but not physically connected to a passage through the cap into the container portion. The spout piece may install on a track seal mechanism whereby the spout may be urged over a seal and may be cut off from liquid passage through the cap and urged back to an open position to again enable drinking from the bottle.

Bottle 112 (2) includes a water volume flow sensor 507 in this embodiment that may be adapted to measure and track the amount of liquid passing through the cap over time. It is important to note herein that bottle 112 (2) may be operated as part of a tracked activity that includes the tracking wrist band device, or as an independent device just to track the amount of liquid a client might consume hourly and daily regardless of other activities. In one embodiment, bottle 112 (2) may include a temperature sensor 512 (thermocouple or other sensor) for measuring and reporting the temperature of the fluids in container 501. Bottle 112 (2) may be adapted as a thermos bottle having material properties that promote slower temperature change from the original temperature of stored liquids. In one embodiment, a UV (ambient light) sensor 513 may be provided and adapted to track a client's time of sun exposure.

A user touch screen interface 505 is provided and located on one side of cap 502 in the form of an embedded liquid crystal display (LCD) display. Display 505 may present a controlling indicium like the Styr logo S icon on touch screen 202 of FIG. 2A. Tapping the control icon may enable screen scroll through any displayed data. Picture icons may be retrieved and displayed wherein those icons represent the various data points that might be viewed on the display like electrolytes consumed, hydration rate in ounces, and temperature of liquid in the container, UV exposure level, ambient environment temperature, or the like.

Bottle 112 (2) may receive notifications through the smart phone aided by the smart phone application. One notification that may be sent to and received at the bottle is a notification to drink and if needed a recommended amount to drink. Further, the notification may be one that is received just before or at the start of an activity to recommend the user drink a recommended amount of liquid and then at every interval of time x during the activity drink another recommended amount. The bottle may be programed to vibrate or make a buzzing sound as a period-based notification to the user to drink from the bottle.

The data received from a connected bottle may be processed at the data processing server aided by SW to calculate data results for user labs and for display at the bottle if so desired by the client. A data processing engine may rely on third-party information like Geo-location and predicted weather information to aggregate substantive data that might be relevant to the client activity and state where that data may not be independently available from a device sensor.

Weather information including humidity levels, particulate levels pollen levels, during tracking activity may cause recommendations to be made by the system during the tracking activity or immediately after the tracking activity to maintain base line goals. In one embodiment, a client may schedule an activity where the bottle will be used during a hike, for example, and may request that the system estimate the appropriate rate of hydrating (taking sips) from the bottle and may recommend packing more than the volume of water or liquid in the bottle based on planned distance of the hike, rate of speed (vigorous pace verses lax pace), difficulty level, local weather and temperature forecast for the estimated time of the hike, elevation, etc.

Recommended daily hydration rate and recommended amounts vitamins and mineral supplement for consumption may shift or be adjusted by the service recommendation engine during progression of the athlete through each of multiple stages of a long training period for example, for an upcoming fight where the athlete may be a martial arts competitor, or for an upcoming marathon where the athlete is a marathon runner. The client's user lab data may be continually updated through continued interaction with the system.

The user labs data may be accessed by the client through the client application and presented to the client on a summary page dashboard screen where the client may tap an icon representing data or select from further options presented in a drop down menu or menu bar to navigate to different data points to assess progress or to view updated data relative to client goal attainment. The devices like the wrist band tracker and the connected bottle may sync data with the client application and receive data for convenient display on those device screens so that the client may see progress against a goal on the device instead of being required to access the application such as while hiking for example. The application may function in a background state using less power and may wake to full foreground state when receiving or sending data or when the application is being navigated to view data.

One with skill in the art will appreciate that use of more than one dedicated device such as the described tracking device 112 (1) and the connected bottle 112 (2) for example, provides unique data points that may be combined in the tracking data and processed along with third party-held data and previously provided client-held data and client use history data reflecting the client's average baseline levels for general fitness state and where those levels are relative to goal levels set through recommendation, coaching, and client desire.

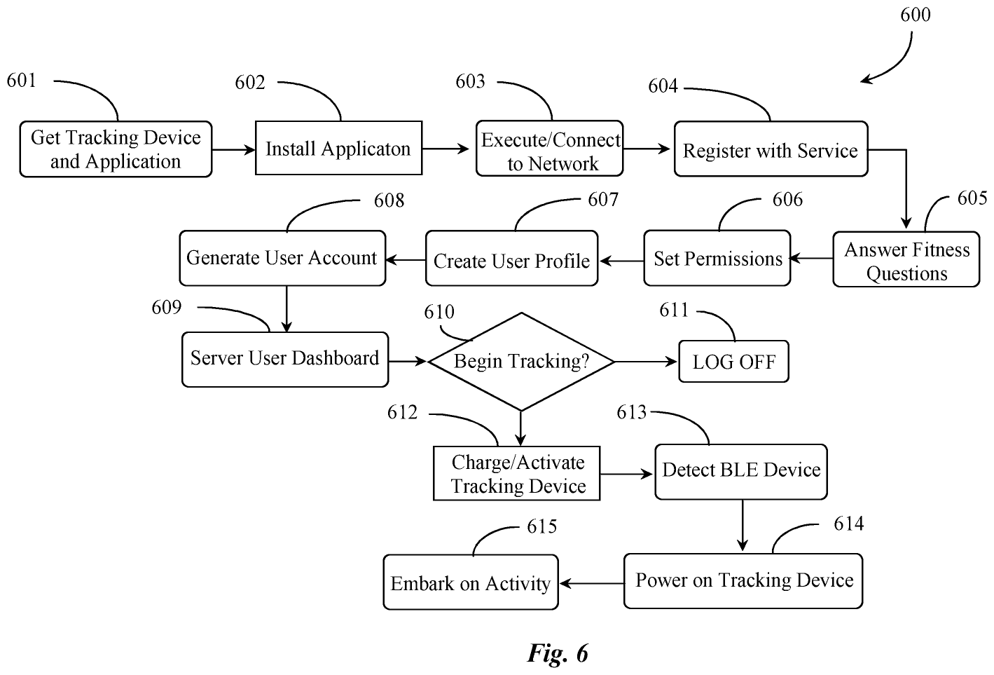

FIG. 6 is a process flow chart 600 depicting steps for getting started and using the service of the invention the first time. At step 601, a client may purchase a starter kit that may include the tracking device (112 (1), FIG. 1) and the smart phone SW application (SW 113, FIG. 1) at minimum. In a preferred embodiment, the starter kit may include the tracking device, the connected bottle, the weigh-in scale, the smart phone application, and a starter amount of vitamin packets, for example 15 single serve liquid packets representing a 15-day supply. In one embodiment different kits may be combined for different client activity preferences. For example, in one embodiment a running kit may be provided whereas a different kit might be provided for body builders. However, each kit will have at least one motion tracking device and will include the application.

At step 602, the client may install the smart phone application. At step 603, the client may execute the application (browser-based) and connect online to a website. At step 604, the client working through the application may register at the web host server for the provided service. In one embodiment, the smart phone application (113, FIG. 1) may be downloaded from a file server through the web site server to the client smart phone or directly to the client smart phone, bypassing the web site without departing from the spirit and scope of the invention.

At step 605, the client may be asked to answer some questions including fitness questions like height weight gender, BMI if known, health questions related to fitness level or capability, medications and so one to enable the base beginnings of a user labs for the client. At step 606 a client may be asked through the smart phone application to select and set permissions parameters for service use of phone applications, voice recognition capability, Geo-location capability, email, text messaging, and camera functions. The SW 113 includes APIs 114 for accessing and using available programs and components of the smart phone hosting the SW.

At step 607, the client may be requested to create a user profile for the website service. The user profile data may include photos, videos, descriptive data, user name, handle, and preferences for specific activities, or other prompted profile information. At some point in the client registration process, perhaps during step 607, the client may be prompted to confirm a user name and may be asked to create and confirm a password and or a personal identification number (PIN) for future log-in. At step 608, the client's registered account is created at the website. The client may be served base data organized as a dashboard summary page in the application as an interactive application dashboard screen in step 609. Since there has been no motion tracking or hydration tracking some data display windows or fields may be blank (no data).

At step 610, the client may determine to track data or not to track data. In one embodiment the client sees a prompt in the dashboard screen asking the client if he or she wishes to track data. If at step 610 the client determines not to track data at this time, the client has registered successfully and may log off the website at step 611. If the client wishes to begin tracking at step 610, the client may charge and activate one or more than one tracking device, in this case the wrist band tracking device and the connected water bottle at step 612.

In one embodiment, in step 612, the electronic devices may be activated while the client is connected to the website through the smart phone application from a dedicated device activation screen. Device identification data may be entered into a data field on the device activation screen of the client's smart phone application, or the application may use optical character recognition (OCR) capability on the phone to capture, as input into the application, a device number such as a device serial number or other identifying indicia. In one embodiment, devices may be voice activated by the client speaking into a VR module through the application. Step 612 may also include pairing the devices with the smart phone for Bluetooth™ communications. Once the devices are fully charged and paired for communication they are ready for use in the field and may be powered off until tracking activity.

If the device or devices used in the ensuing tracking activity have been powered off after activation, charging, and device pairing is step 612, the client may power the devices on at step 613 presumably just before active tracking. Motion tracking device 112 (1) of FIG. 1 may not include any physical switches or buttons and may rest in a sleep state and may wake into boot mode when the motion sensor detects movement of the device. In one embodiment, the connected water bottle 112 (2) of FIG. 5 has a power on/off switch.

In another embodiment, the bottle wakes from a sleep state when it is filled with liquid and goes back into a sleep state when the bottle becomes empty. In another embodiment, Bluetooth™ network recognition of the device or devices such as in step 614 by the smart phone with the application running in the foreground may wake the devices from sleep mode, for example, if they were not active in tracking data to transfer data from the devices to the smart phone. In step 614, the devices may already be active and tracking data before the client leverages the smart phone and application to pair the devices and participate in wireless data transfers between the phone and the devices. At step 615, the client may embark on a tracked activity.

It is important to note herein that there are different modes for active data tracking relative to an activity like a run, for example. One may be a static tracking mode using the devices where tracked data is held on each device and device reporting (to smart phone) is delayed until after the activity and the client opens the application and prepares to receive data from the devices. Another mode may be a passive tracking mode wherein the tracked data is not held on each device but instead sent wirelessly to the smart phone application while the application is running on the smart phone during the activity.

In the passive mode described above, the smart phone is not connected to the Internet, but notifications set in the application by a client such as interval-based drink reminders may be sent to the bottle device from the smart phone application while the device is in use on the activity. A third mode may be a live tracking mode wherein the devices are running and tracking data and sending the data to the smart phone running the smart phone application during the activity. In this mode the smart phone is connected to the Internet and transfers the tracked data to the data processing service for processing results and generating recommendations (notifications).

The service may provide calculated results that are propagated back through the smart phone application to each device over the Bluetooth™ network like for example, current number of calories burned, or current number of liquid ounces that have been so far consumed. These data points may be displayed at any point in the activity or at any point during the activity that the client determines to pause and call the values up on the tracking device(s). In a live mode, data may also be transferred in a batch mode wherein at the back end; data processing and recommendations comply with the general parameters of batch processing. For example, a three-hour trail hike live/batch mode on a loop may be tracked wherein in the tracked data is sent as batch data every one-half hour into the hike. It is important to note herein that third party held data may be retrieved by the service in real time and used during processing of data results (labs) whereas such processed data may be deemed instrumental in forming logical basis for generated recommendations or notifications sent back to the client.

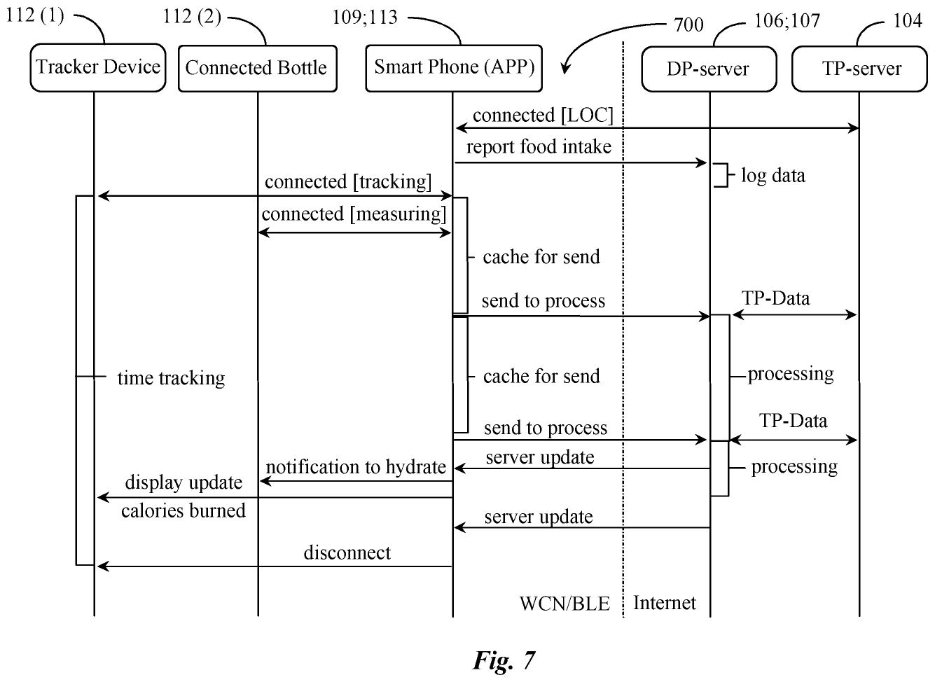

FIG. 7 is a sequence diagram 700 depicting node connectivity, data aggregation, data access, data processing, and data updating within a time window of a live activity. Sequence diagram 700 depicts interaction between nodes on a network including the Internet hosting a data processing (DP) server analogous to servers 106 and 107 of FIG. 1 aided by SW applications 122 and 123. In this example functionality is combined onto one server for data processing to simplify description for this sequence; however the SW may be distributed over more than one server that may be dedicated to different categorical functions without departing from the spirit and scope of the present invention.

Tracker device 112 (1) connected bottle 112 (2), and smart phone 109 running a smart phone application 113 are connected for wireless communications using Bluetooth™ (BLE), and smart phone 109 is connected through application 113 through a wireless carrier network (WCN) to the Internet. Referring now to the sequence, the client operating smart phone 109 aided by SW 113 is connected to third party (TP) data server to report GEO-location of the user in real time. Location is turned on, so the client location may be known. Geo location is important for accessing additional third-party information to use in data processing along with location data.

Smart phone 109 may connect to the data processing server through the smart phone application to report food intake or consumption. In actual practice a web server may function as a proxy between the smart phone application and the data processing server without departing from the spirit and scope of the invention. A website server is not depicted in this example to save illustration space and simplify description of the sequence. Documenting or logging food intake is conducted through the smart phone application while connected to the server.

The interaction may be through an artificial intelligent (AI) chat service that uses recognition of the user's voice (IVR) in one embodiment to log information. For example, the user may say I just ate a stack of three pancakes and syrup with a medium glass of orange juice. The system recognizes the items and relies on aggregated knowledge held in a knowledge base to categorize them and determine serving size, caloric amount, nutritional amounts including vitamin count and percentage of daily recommendation for the user. The client may also type the input, take a photo of the food and submit that photo, or allow the application to optically recognize a packaging bar code with the required information. If the client does not provide enough information for the server to reliably estimate the caloric amount etc. for a food item, the AI module may ask the client questions to obtain better information.

DP server (106,107) may log the client contribution for the client into a user lab that holds all the client's current and updated nutritional and physical status information. Logging the new information received through the AI module may result in calculations that change one or more total values listed for the client and that are viewed in a dashboard summary in the client's smart phone application.

Sequence 700 is assumed a live network interactive sequence where once connected to the data processing server through the smart phone application, the client may become connected to the tracking device whereby the tracking device begins data tracking and to the connected water bottle whereby the water bottle (assumed filled) begins measuring any liquid passing the cap when the client drinks. It may be assumed then that the client has reported food intake prior to an event that will be tracked and has begun active tracking at some point after the food intake and logging.

One the client has connected to the tracking device time tracking is recorded by the tracking device while the device is on and tracking data for the client. Connected bottle 112 (2) may be connected just after tracking begins assuming the bottle is full and ready for use. In this live example, the client phone remains on and connected and may receive tracked data from tracking device 112 (1) as soon as available during the tracked activity. Likewise, measurements from the bottle are transmitted to the smart phone application as soon as available during the tracked activity.

Tracked motion data and measured hydration information may be cached at the smart phone for a temporary period. The length of the period may be arbitrarily set by the client or in one embodiment recommended by the system. At the end of a batch period, the smart phone may automatically send the cached motion data and hydration data to the data processing server based on expiration of a period as a trigger to send. For example, if a planned activity is estimated to take four hours, the batch data period may be set at every one-half hour or eight transfers of data for processing. In one embodiment, a batch of data cached on the smart phone is defined as data collected and received the aggregate thereof having a predefined data weight equal to a called out “batch weight” of data. In this embodiment, as soon as the data weight is achieved in cache on the smart phone, a trigger causes the data to be transferred over the network to the data processing server through a proxy server or directly.

When the data processing server receives data on behalf of a client during an activity, it immediately begins sorting and processing the data for the client and may receive and or retrieve third party information from one or more TP servers analogous to server 104. Location data is, of course paramount and may be provided during the activity with the GPS feature on the client's smart phone turned on. Location data also provides key data for retrieving additional third-party data. Third party data may be retrieved by the system of the invention through request (server to server) and passively through screen scraping and snapshot technologies.

Smart phone 109 aided by application 113 continues to receive additional motion tracking data and hydration data after sending the previous batch data to the data processing server and may immediately cache that data as part of the next new batch of data to send to the data processing server. The data processing server aided by the core processing application may be engaged in processing the previous batch of data while the smart phone is caching the next batch of data for send.

Data processing server may update current data available to the smart phone application 113 with new information while the current tracked activity ensues. The server may also send recommendations and or notifications to the client's smart phone while the planned activity ensues, whereby in turn the smart phone application may send data resulting from calculation to display on the connected bottle or the wrist band tracking device through the Bluetooth™ LE network. For example, smart phone 109 may pass on a notification to the client relative to a recommendation to hydrate or to adjust the frequency of hydration up or down. The notification or recommendation may be received wirelessly at the bottle and displayed on the connected bottle 112 (2) on the electronic display screen. Likewise, data may be passed from smart phone 109 to tracking device 112 (1) for display on the electronic display screen.

In one embodiment of the invention, a live tracked activity may be remotely coached by an Artificial Intelligence (AI) coaching application wherein a recommendation sent to a client may be coaching advice for a current situation. For example, if calculations made with the aid of third-party data indicate that more water needs to be consumed by the client, then a notification or recommendation may be generated at the server and sent to the smart phone and passed on to the targeted device. In a variation of this embodiment, a sound clip may be generated in synthetic voice at the server and transferred ultimately to an additional Bluetooth™ device head set having at least one speaker and firmware containing a set of instructions for a sound player to play the notification to the user. In another embodiment, the smart phone opens and plays the file streaming the content live wirelessly to the Bluetooth™ enabled head set worn by the client during the tracked activity.

In another embodiment, there may be a mode that enables both devices to receive the same notification or data point to display simultaneously allowing the client to look at the most convenient display at that time. Notifications may also trigger illumination, vibration, and or sound to alert the client practicing the activity of the notification. At the end of the tracked activity the client may disconnect from the peripheral devices and stop recording data.

In one embodiment, when the client is done tracking and disconnects from the peripheral devices, the smart phone is still connected online with the data server and notifies the data server of the end of the event or last batch of data for processing. The above information enables the server to finish processing the last batch data without calculation for current notification data to be sent back to a client. Moreover, since the client is finished tracking that activity the server may update user labs, so the client may access and see activity results and information relative to the activity and any overall goal the client might have.

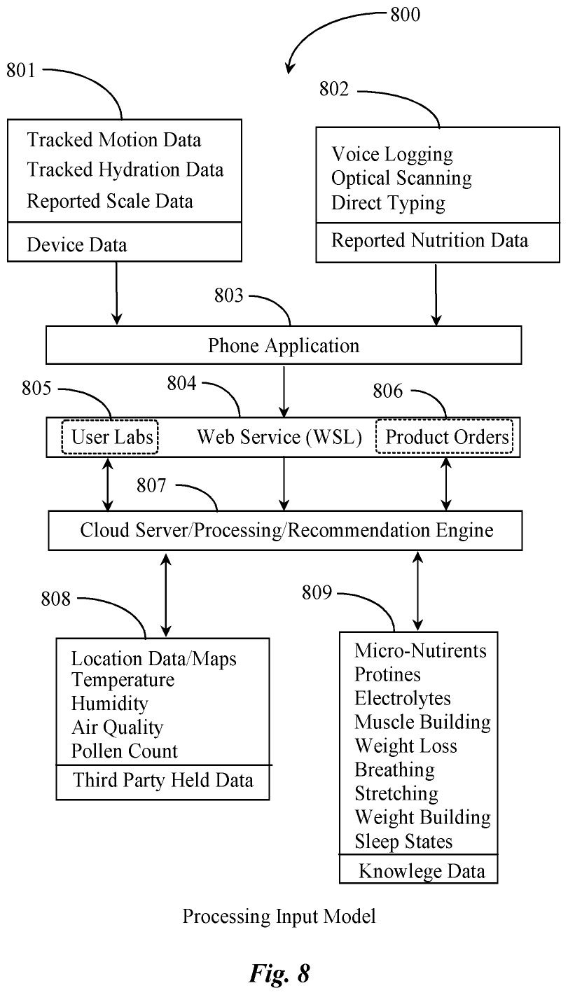

FIG. 8 is a block diagram depicting a data process input model 800. The core of input model 800 is a data processing and recommendation SW engine running on a data procession and or recommendation server that may, in one embodiment be hosted in a cloud network.

Beginning on the client side of model 800, device data object 801 represents data input into a smart phone application object 803 from the device over the local wireless network. This data may include but is not limiting to tracked motion data, tracked hydration data, reported scale data, UV exposure data, and heart rate data. Other data might be included such as elevation, NSEW orientation, ambient temperature, dependent on capabilities of a tracking device without departing from the spirit and scope of the invention.

Reported Nutrition/Spec. object 802 represents information directly input into the phone application by the client including voice logging (IVR), optical scanning, direct typing, and image recognition. Food consumption, beverage consumption, and specifications for equipment that might be used in a tracked activity. It is noted herein that an intermediate object web service object 804 may exist between the phone application and the core object 807. In this embodiment web service object holds the attribute user labs 805 and the attribute orders/history 806.

Web service 804 may be the log-in destination for the client through the smart phone application and may serve as a communication stop or broker between the client and the data processing server. The web service object 804 forwards the phone application input data to the processing and recommendation engine object 807. Engine 807 may also receive as input or retrieve data from user labs attribute 805 and may update attribute 805. Engine 807 may also receive as input or retrieve data from orders history attribute 806 and may update attribute 806. In this embodiment, the client may view user labs and orders status and history without connection to the data processing server.

Data processing/recommendation engine 807 may receive as input or may retrieve data from a third party held data object 808 over the wider network or the Internet network. Third party data 808 may include but is not limited to location data including Geo-coordinates and mapping data. Mapping data may include features, terrain characterization, locations of nearby businesses, sources of water, sources of nutrition, etc. Data 808 may include real time or forecast data points like temperature and humidity levels. It is noted herein that some data points available through third party data sources may also be tracked at the client location by one or more devices. Data 808 may include general air quality information like rated information describing air quality as good, moderate, or dangerous.

Data 808 may also include pollen count information for a location and time, including forecast data. In one embodiment of the invention, third-party data or client-reported data may include specification data about specific pieces of equipment or accessories the client is leveraging during an activity. Third party held data may include standard specification data relative to one or more than one standard piece of equipment the client may use during a tracked activity. For example, if a client has a kayak and a kayak paddle, standard specifications of the kayak and paddle (weight, surface displacement, paddle length, breadth of paddles, weight of paddle, etc.) may be obtained during data processing of tracked data obtained from the client side and used by the data processing engine as weight factors in calculations or the specs might be normalized into a value for each specification description whereby those values may be then inserted as normalized algorithmic variable input.

It is important to note herein that equipment specifications that are standard and in some cases that are unique and reported by the client may have an effect on results calculated for the client and updated to user labs. In another embodiment, a client may use a standard resistance band while engaging in a jogging activity wearing a 5-pound weight on each leg. System knowledge of the devices added to the activity and access to the specification data of those devices improves the system's ability to estimate results more accurately and in a more precise nature. Notifications and recommendations sent to a client may also be relevant to a piece of equipment being used. For example, if a client is hiking (live mode) to burn a total number of calories and is wearing 5-pound weights, the system may inform the client in real or near real time to take off the weights when the calorie goal is attained, which may be well before the end of the hike. In this case the benefit to the client is more stable management and conservation of energy (during the activity).

Data processing recommendation engine 807 may also receive input or retrieve data from a knowledge base object 809 representing a knowledge database of vetted technical information available to the process including access to rules and instruction for searching and using information in the knowledge base. Knowledge in knowledge base 809 may include but is certainly not limited to micro-nutrients, nutrients, proteins, electrolytes, muscle building information, weight loss information, breathing information (exercise), stretching information (exercise), weight building, sleep states, etc. Knowledge data 809 aids the processing body to determine if recommendations and notifications should be propagated to an active client recording an activity in the field.

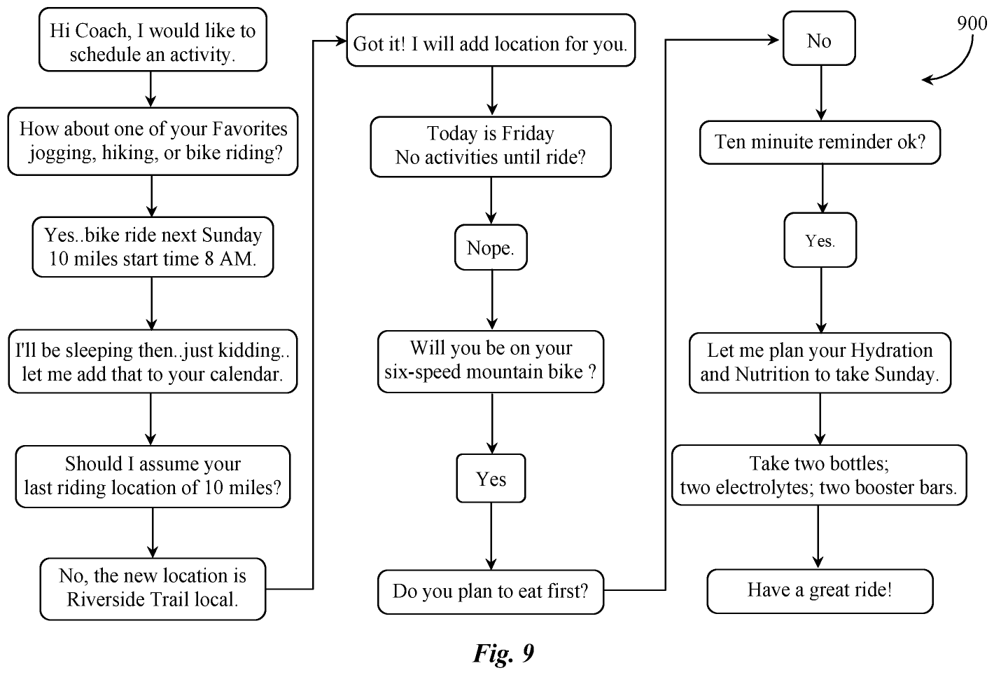

FIG. 9 is an exemplary transcript of an interaction 900 of an artificial intelligence (AI) service communication with a user planning a future activity according to an embodiment of the present invention. In one embodiment of the invention a client may plan a tracked activity. The system of the invention may aid the client planning an activity by servicing the client in putting the data in a client schedule, notifying the client of the time of the activity, and planning nutrition up to and for the activity.

The AI chat interface may be accessed through application 113, FIG. 1 and may be triggered by the client such as by tapping on a mic icon or IVR icon to start speaking. Reading in the first column top left, the client may begin by stating a request, which in this case is a request to the AI coach to schedule an activity the client has planned. The AI coach interprets the client speech and responds intelligently with presentation of three of the client's favorite activities for client selection. This data is available to the AI coach platform by accessing the client's activity history.

The client may select one of the presented choices saying “yes”, bike ride next, Sunday starting at 8 AM. This response may trigger the AI coach to create an entry to add to the client's activity calendar. The AI coach response is natural and may contain strategic elements of entertainment in response to a client to foster positivity or levity in the client. In the depicted response the AI coach jokes about being asleep that early and then invokes the calendar to add data. Additionally, the AI coach keeps the conversation going by asking the client if this ride location might be the same location of the last ride of the same number of miles accessed from the client activity history.

The client then responds in natural language “no that the new location is Riverside Trail”. The AI coach has access to third party held data and may look up the location Riverside Trail before asking the client any further questions. Reading now from top center column, if the AI platform locates the information on Riverside Trail, the coach may respond “Got it!” I will add the location for you. If the AI coach cannot find a location the coach may ask for the location details from the client.

Once the event is on schedule, the AI coach may want to confirm whether the client plans any other prior activities that might be tracked beforehand that are not on the schedule. If the client has planned other activities the AI coach may want to incorporate that activity description as well, especially if the system will estimate required nutrition and or hydration or give an estimate of a goal-oriented value. In this case the client plans no activity beforehand. In this embodiment, it may be assumed that third party data includes equipment data held third party or client provided. The AI coach asks the client if the client will be using her six-speed mountain bike. In this case the client has registered the basic equipment specifications of the mountain bike into client profile data and the bike has been used in a previous activity making it known to the AI coach in activity history of the client.

In this example, the client responds with a yes confirming planned use of the bike in the ten-mile ride. The bike has a weight and gear torque specs for each of the six gears. This information might be used to fine tune calculated user data during the activity. For example, by understanding the ten-mile route in terms of slopes (uphill, downhill), switchbacks, straight portions, rugged or smooth trail surfaces, the system might make a reasonable prediction which gears on the bike will be most involved for step or peddle counts and may produce finer granularity on calories burned. Force data required to operate the bike in each of the gears (straight or uphill) may contribute to final predictive results relative to a client goal such as toning or muscle building.

In one embodiment, part of the service to clients planning an activity is recommending the optimum nutrition and hydration for the day of the event. The AI coach may ask if the client plans to eat on the morning of the event before the event. If so that might affect a recommendation for nutrition. In this case the client will not eat prior to the activity as depicted herein by a no answer top right column. The AI coach may confirm whether the client want a notification reminder of the event that morning before the event and may suggest an arbitrary ten minutes. In this case the client agrees and says yes. Otherwise the client could state the time of the reminder relative to the start time of the activity.

Once all the information is available to the AI coach, the data processing engine may be used to suggest with reasonable accuracy what types of nutrition (proteins, carbohydrates, etc.) to recommend to the client for the activity as well as estimating what electrolytes and water amounts will be required to maintain healthy hydration, prevent cramping, and so on. Once the system has finalized an approximation for recommending the nutrition for the activity to the client, the AI coach may state the estimated requirements to the client.

In the above case, the system recommends to the client to take two bottles (connected bottle and refill bottle), two packets of electrolyte (one per bottle volume), and two protein booster bars. Further recommendation data may be more granular recommendations like how often to drink an ounce of liquid during the activity or when exactly to consume one or both booster bars. The recommendations by the system may also be updated to the tracking and or measuring devices as described further above. The AI coach may sign off with the client if the client requires no further assistance with scheduling or anything else with “have a great ride” in natural language.

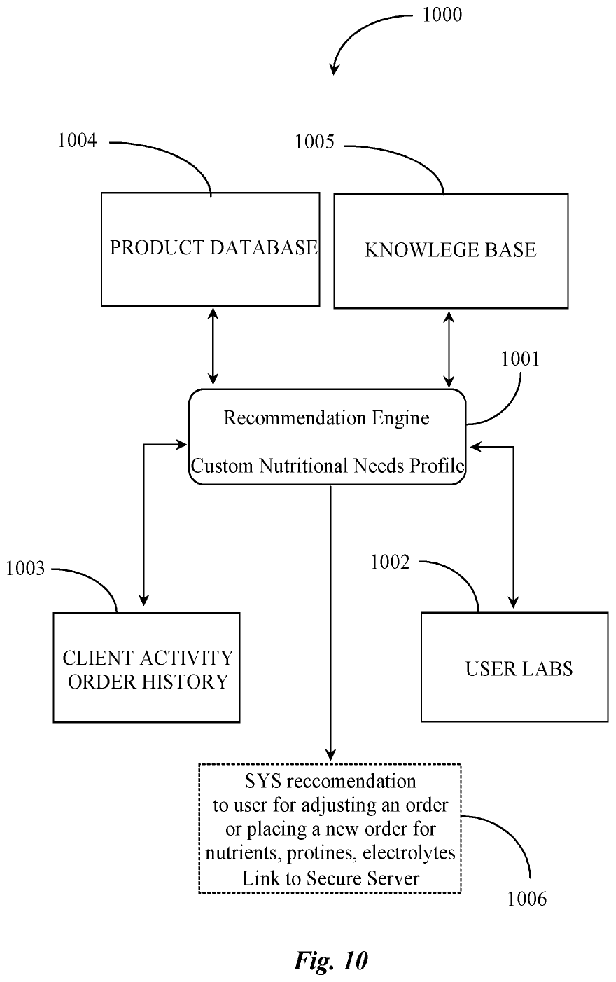

FIG. 10 is a block diagram 1000 depicting data source nodes accessible to a recommendation engine for generating system recommendations. Recommendation engine 1001 is adapted to take input data and process it to determine recommendation or notification data to send back to a client. Recommendation engine 1001 may be combined with the data processing engine or may be hosted separately and take input data from the processing server without departing from the spirit and scope of the present invention.

One goal of the present invention is to produce a nutritional needs profile for a client that best optimizes client health. Recommendation engine 1001 has network access to user labs 1002 and can take data from user labs as values for calculation and or to use as weighting factors in calculations. Recommendation engine 1001 has network access to a client activity and product order history 1003, which may be held at the website brokering communication with the data process and the client. Activity data may summarize a history of tracked activities without the user labs data associated with it. Client order history includes the products ordered by the client, pending orders, pricing, payment history, etc.

Recommendation engine 1001 has network access to a product database 1004. Product database 1004 may include data about all nutritional products known to the system and any hardware software products known to the system that might be sold to a client. Vitamin mixes (liquid and powders); proteins (shakes, bars, etc.), minerals and electrolytes, and other nutrition products may be offered. Hardware products like scales, blenders, wrist tracking devices and accessories may also be listed in product database 1004. Recommendation engine has network access to a knowledge base repository 1005. Knowledge base 1005 contains vetted knowledge relative to athletic nutritional requirements for every vitamin and nutrient and how it may affect a user.

In one embodiment knowledge base 1005 may contain knowledge about vitamin and nutrient requirements for people with different DNA profiles that may process specific nutrients differently influencing recommended amounts and knowledge of hereditary predispositions to certain conditions wherein a special vitamin mix might be recommended to help keep such a condition from developing or worsening if already acquired by the client. Recommendation engine 1001 may output a system (SYS) recommendation 1006 to a user for adjusting a current product order or placing a new product order for vitamins nutrients and or proteins based on findings of the recommendation engine that may be the result of further calculation and data sourcing beyond processing data for user labs. Recommendation 1006 may appear in the browser-based application on the client smart phone. Recommendation 1006 may include an executable link to a secure transaction server for the client to carry out a transaction like authorizing a change to an existing blanket order or placing a new order for products including vitamins, proteins, and nutritional supplements.

In one embodiment, knowledge data about human deoxyribonucleic acid (DNA), particularly, gene variants common to various percentages (common to rare) of people and how they may affect nutrient processing such as vitamin absorption, fat breakdown, calorie burning metabolism, and food sensitivity. This data may be aggregated from vetted sources and or contributed by vetted sources and stored for later access by the data processing/recommendation engine to determine if a client with particular gene variants relative to identified nutritional categories or references in the knowledge base may need more or less of a particular nutrient, or may benefit from system recommendation relative to food consumption, food purchases liquid consumption vitamin consumption, sleep pattern, or the like.

In one embodiment, a client may submit DNA via an approved DNA kit and method to the service of the invention. The service in turn may solicit and procure professional DNA processing and analysis (Third Party) of the client's DNA relative to the genes and variants thereof shown to exist in humans and that may affect how humans process foods (including dealing with cravings), nutrients, and how humans manage metabolism etc.

In one embodiment four general categories are observed, food sensitivity, food break down, hunger and weight, and vitamins. The DNA test and analysis may, in one embodiment, record only the client's specific genes and variants that may be relative to each category described above as identified in the knowledge data aggregated and stored for access for each gene and variant thereof. Granularity in the aggregated knowledge may extend to specific combinations of two or more relevant genes and their combined variants including on and off states for a gene or variant thereof.

After a client submits a DNA sample, the DNA processing and analysis party may provide the data results specific to the client to the service for addition to client's user labs enabling the client access to the information through the smart phone application. A full DNA profile may not be required in processing the DNA because of the narrow focus on genes and variants thereof that affect human nutrition. Recommendation engine 1001 may take specific client DNA information from user labs and access knowledge data specific to the genes and variants thereof listed in the client information. The recommendation engine may determine specific information found relative to the client DNA profile justifies a quantity adjustment recommendation in an existing order (up or down) or perhaps a new order recommendation relative to nutritional products.

In one embodiment, the recommendation engine may further give AI advice based on analysis of the client DNA against the relevant knowledge data such as a recipe that might lessen a bitter taste a user has for a specific nutritional vegetable, for example, wherein the bitter taste is caused by a variant of an active gene. In one example, under food sensitivity there may be 5 relevant genes including the known variants thereof that tend to affect human sensitivity to certain foods. These genes are ORIOA2 (sensitivity to cilantro), CYP1A2 (sensitivity to caffeine), TAS2R38 (bitter/non-bitter taste tendency), ALDH2 (sensitivity to alcohol), and MCM6 (sensitivity to lactose). These genes have variants shared by percentages (common to rare) of the population. In a next category of food breakdown or how human metabolism breaks down food into good and bad fats, there are PPARg (monounsaturated fat), KCTD10 (cholesterol and lipids), and FADS1 (fatty acid response).

Referring now to gene ORIOA2 (sensitivity to cilantro), listed variants are AA, AG, and GG with GG being rare. The first two variants show high tolerance for cilantro meaning the client likes the taste and is not sensitive to it. However, those 10 percent of a population with the variant GG of ORIOA2 are more likely to despise the taste of cilantro. The DNA test tests for all the variants of the stock gene. In this case the system may recommend cilantro replacement herbs like parsley or Thai basil in place of cilantro for many Latin and Asian cuisines that include healthy portions of cilantro. Cilantro is a good source of antioxidants, vitamins, and essential oils.

Referring now to gene CYP1A2 (sensitivity to caffeine), listed variants are AA, AC, and CC with the variant CC being rare. If a client shows AA they are in a forty percent of the population that metabolize caffeine up to 4 times faster than those with the rare variant CC, which is about 15 percent of the population classified as slow to metabolize caffeine. Those having the variant AC represent 40 percent of the population that carry a slow copy and a fast copy of the gene but are considered slow to metabolize caffeine. So, if a client is AA then he or she is considered tolerant of caffeine. The system may along with other data take this information into account and may begin recommending small or moderate amounts of caffeine during an activity to produce more energy and burn calories faster, the system aware that the client can handle it due to the DNA data associated with that client.

In one embodiment, the DNA data may be provided by a third-party lab under contract with the service provider. Experts in the field of nutrition and DNA may provide the general knowledge data relative to the effects of the active genes and variants thereof on the client. Knowledge data may come from vetted professionals having appropriate degree and experience in DNA and nutrition management. Knowledge data may result from clinical studies that have been vetted by at least one independent party.

It will be apparent to one with skill in the art that the data tracking and recommendation system of the invention may be provided using some or all the mentioned features and components without departing from the spirit and scope of the present invention. The arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. It will also be apparent to the skilled artisan that the embodiments described above are specific examples of a single broader invention that may have greater scope than any of the singular descriptions taught. The invention is limited only by the breadth of the claims below.

What is claimed is:

1. A data aggregation, analysis, and results reporting network for fitness state management for users comprising:
a first machine readable code executed from a non-transitory medium running on at least one first network node, the first network node tracking at least raw motion data of individual ones of the users;
a second machine readable code executed from a non-transitory medium running on least one second network node, the second network tracking at least raw hydration data of individual ones of the users;
a third machine readable code executed from a non-transitory medium running on a third network node, the third network node receiving the raw data tracked by the at least one first and second network nodes and caching the data as a batch of data for processing; and,
a fourth machine readable code executed from a non-transitory medium running on at least one fourth network node, the fourth network node receiving the cached data from the third network node and processing the data wherein the at least one fourth network node has network access to at least one fifth network node, the fifth network node sending third-party data to the at least one fourth network node during data processing of a received batch of data;
wherein the at least one fourth network node sends processed data results back over the network to the third network node, the results relevant to the last received and processed batch of data while the third network node is receiving in real time subsequent raw data from the at least one first network node and the at least one second network node and caching that data as a subsequent batch of data for data processing into results.

2. The data aggregation, analysis, and results reporting network of claim 1, wherein the at least one first network node is a wearable data tracking device adapted to track at least motion data and the at least one second network node is a liquid tracking device installed on a water bottle as a cap piece to the bottle.

3. The data aggregation, analysis, and results reporting network of claim 1, wherein the third network node is a smart phone having a user interfacing browser-based SW application executed and running, and wherein data received from or sent to the at least one first network node and the at least one second network node is transmitted over a Bluetooth LE™ wireless network.

4. The data aggregation, analysis, and results reporting network of claim 1, wherein the first machine readable code and the second machine readable code call out in aggregate specific data types tracked and aggregated including but not limited to motion data, hydration data, direction of motion data, time data, date data, heart rate data, temperature data, time of ultraviolet light (UV) exposure data, humidity data, and elevation data.

5. The data aggregation, analysis, and results reporting network of claim 1, wherein the third machine readable code contains instructions for at least receiving raw tracked data, sorting received raw tracked data, caching received and sorted raw tracked data as a single batch of data, and sending the received, sorted, and cached raw tracked data as a single batch of data.

6. The data aggregation, analysis, and results reporting network of claim 1, wherein the fourth machine readable code contains instructions for at least receiving the sorted tracking data as a batch of data for data processing, normalizing the batch of data for data processing, receiving third party data, mapping received third party data to processing input, and storing the resulting data after processing as a batch of processed results data.

7. The data aggregation, analysis, and results reporting network of claim 1, wherein the at least one fifth network node is a GPS information server serving user location and providing live mapping services for the user.

8. The data aggregation, analysis, and results reporting network of claim 1, wherein the at least one fifth network node is a weather forecast server serving current and forecast weather information including but not limited to current or forecast temperatures, humidity levels, wind speeds, pollen counts, general air quality levels, pollution particulate counts.

9. The data aggregation, analysis, and results reporting network of claim 1, wherein the at least one fifth network node is an original equipment manufacturer (OEM) server serving specifications of equipment registered for use during tracking of data of the users.

10. The data aggregation, analysis, and results reporting network of claim 1, wherein the at least one fifth network node is a video server serving local video of users participating in a tracked activity the video data appended with traffic data pertaining to a number of other users at the activity and their locations along the active route.

11. The data aggregation, analysis, and results reporting network of claim 1 further including a sixth network node in a network communication path between the at least one third network node and the at least one fourth network nodes, wherein the sixth network node functions as a proxy server and communications broker between the at least one third network node and the at least one fourth network node.

12. The data aggregation, analysis, and results reporting network of claim 11, wherein the sixth network node has access to user labs data, user order history data, and user profile data and may server that data to the at least one fourth network node upon request from the at least one fourth network node during processing of tracked data and third-party data.

13. The data aggregation, analysis, and results reporting network of claim 1, wherein a batch of data cached on the at least one third network node is defined as data collected and received over a specified proportional and repeated period of time within the overall activity period.

14. The data aggregation, analysis, and results reporting network of claim 1, wherein a batch of data cached on the third network node is defined as data collected and received the aggregate thereof having a predefined data weight equal to a batch weight of data.

15. The data aggregation, analysis, and results reporting network of claim 1, further including an optional fifth machine readable code executed on demand from a non-transitory medium running on a seventh network node, the seventh network node tracking at least weight data of individual ones of the users, wherein the weight data is compartmentalized into sub-values of total measured weight of the individual user quantifying at least lean muscle weight, and visceral fat weight, and wherein the data from the seventh network node is cached at the third network node independently of active raw tracking data cached as batch data.

16. The data aggregation, analysis, and results reporting network of claim 15, wherein the seventh network node is a weigh scale adapted with an embedded bio electrical impedance system.

17. The data aggregation, analysis, and results reporting network of claim 3, wherein the results of data processing include result data added to user labs data, the user labs data maintained on the network for the user and accessible to the user through the smart phone application.

18. The data aggregation, analysis, and results reporting network of claim 3, wherein a portion of the results of data processing are utilized in further data processing at the at least one fourth network node to generate recommendations and or notifications that are sent back over the network to the smart phone application and, in some cases, on through the smart phone to the at least one first and or the at least one second network nodes for display.

19. The data aggregation, analysis, and results reporting network of claim 1, wherein a batch of data is defined as all tracked raw data collected from a single tracked activity or, as all tracked raw data collected during a period of hours.

20. The data aggregation, analysis, and results reporting network of claim 19, wherein the batch of data is equivalent to all of the tracked data for a single period of activity tracking and wherein data tracking, data transfer, data processing, and data and recommendation and notification activities occur continuously during the tracking period.
